(19) United States
(12) Patent Application Publication
(10) Pub. No.: US 2013/0019732 A1
(43) Pub. Date: Jan. 24, 2013

(54) ELECTRODE PLATE MANUFACTURING APPARATUS

(71) Applicant: Hiroaki Yotsumoto, Tokyo (JP)

(72) Inventor: Hiroaki Yotsumoto, Tokyo (JP)

(73) Assignee: MITSUBISHI HEAVY INDUSTRIES, LTD., Tokyo (JP)

(21) Appl. No.: 13/636,534

(22) PCT Filed: Mar. 22, 2011
(86) PCT No.: PCT/JP2011/056858

§ 371 Date: Sep. 21, 2012

(30) Foreign Application Priority Data
Mar. 26, 2010 (JP) 2010-073169

(51) Int. Cl. H01M 4/04; B26D 5/00; B26D 1/14; B26D 7/06

(52) U.S. Cl. 83/331; 83/523; 83/613; 83/404; 83/591

(57) ABSTRACT

An electrode plate manufacturing apparatus of the present invention includes an original plate support portion that supports an original plate of an electrode plate coated with an electrode active material, a first cutting blade that forms a linear first cutting portion in the original plate, a first support substrate, which is arranged to face the original plate support portion, having the first cutting blade fixed thereto, a second cutting blade that forms a linear second cutting portion in the original plate, a second support substrate which is arranged to face the original plate support portion, having the second cutting blade fixed thereto, and a driving portion that drives the first and second support substrates, wherein, when the first support substrate is driven by the driving portion, the first cutting portion is formed by the first cutting blade.

### TECHNICAL FIELD

The present invention relates to an electrode plate manufacturing apparatus.

Priority is claimed on Japanese Patent Application No. 2010-073169, filed on Mar. 26, 2010, the content of which is incorporated herein by reference.

### BACKGROUND ART

Conventionally, battery cells have been used as power sources of various electrical devices. A secondary battery, which is a rechargeable battery cell, may be used as a power buffer such as a power generating device as well as the power source. As a configuration example of the battery cell, there are two types: a stacked-type in which a plurality of positive electrode plates and a plurality of negative electrode plates are stacked with separators interposed between them; and a wound-type in which one positive electrode plate and one negative electrode plate are wound with a separator interposed between them. In an electrode plate (a positive electrode plate or a negative electrode plate) of either type, a surface of a collector is coated with an electrode active material.

For example, Patent Document 1 discloses a method of manufacturing an electrode plate of a stacked-type.

In Patent Document 1, after forming an original plate by coating a surface of a sheet-like collector with an electrode active material, the original plate is die-cut using a cutting die (a Thomson die), so that a substantially rectangular electrode plate is manufactured. The cutting die is one in which a band-like cutting blade (a Thomson cutter) is vertically fixed to a support substrate, and a pressing member formed of an elastic material is attached thereto while covering the cutting blade. In a state in which the cutting die does not press the original plate, the pressing member protrudes from the support substrate above the cutting blade. That is, since the cutting blade is embedded in the pressing member, a blade edge of the cutting blade is hidden in the pressing member and thus not seen as if the cutting blade is inside the pressing member.

When the cutting die presses the original plate supported by a support, the pressing member is compression-deformed, so that the cutting blade protrudes from the support substrate above the pressing member. The original plate is pressed toward the support by a pressing force of the pressing member and cut by the cutting blade, so that the electrode plate is formed.

In Patent Document 1, in case of the cutting blade having a shape of a single-edged blade, a load is not applied to the cutting surface of the electrode plate. Therefore, a burr or a crack of an electrode active material hardly occurs.

### PRIOR ART DOCUMENT

### Patent Document

[Patent Document 1] Japanese Patent Application, Laid-Open No. 2003-100288

### DISCLOSURE OF THE INVENTION

### Problems to be Solved by the Invention

However, even when the technique disclosed in Patent Document 1 is used, the electrode active material may be exfoliated and missed from the collector, or be separated from the collector at the corner of the electrode plate. Thus, there has been a problem in that a manufacturing yield is low.

The present invention is made in light of the above problems, and it is an object of the present invention to provide an electrode plate manufacturing apparatus in which the manufacturing yield is improved by minimizing separation of an electrode active material at the time of die-cutting an electrode plate.

### Means for Solving the Problems

In the present invention, in order to achieve the above object, the following configuration is employed.

An electrode plate manufacturing apparatus according to an aspect of the present invention includes an original plate support portion that supports an original plate of an electrode plate coated with an electrode active material, a first cutting blade that forms a linear first cutting portion in the original plate, a first support substrate, which is arranged to face the original plate support portion, having the first cutting blade fixed thereto, a second cutting blade that forms a linear second cutting portion in the original plate, a second support substrate, which is arranged to face the original plate support portion, having the second cutting blade fixed thereto, and a driving portion that drives the first and second support substrates, wherein when the first support substrate is driven by the driving portion, the first cutting portion is formed by the first cutting blade, and when the second support substrate is driven by the driving portion, on the original plate in which the first cutting portion is formed, the second cutting portion is formed by the second cutting blade to intersect with the first cutting portion.

In this electrode plate manufacturing apparatus, the first cutting blade forms the first cutting portion, and the second cutting blade forms the second cutting portion on the original plate in which the first cutting portion is formed. A portion in which the first cutting portion intersects with the second cutting portion becomes a portion that configures a corner of an electrode plate to be die-cut. As described above, two sides that configure the corner of the electrode plate are cut at different timings.

Thus, unlike the case in which two sides connected to the corner are cut at the same time, since the original plate is prevented from being compressed from the two sides at the same time, separation of the electrode active material is reduced and prevented.

### Effects of the Invention

According to the electrode plate manufacturing apparatus, an electrode active material can be prevented from being separated in the corner of an electrode plate, and thus a manufacturing yield can be improved.

### BRIEF DESCRIPTION OF THE DRAWINGS

FIG. 1 is a perspective view schematically illustrating a configuration example of a battery cell.

FIG. 2A is a plan view illustrating an electrode plate.

FIG. 2B is a cross-sectional view taken along line A-A′ of FIG. 2A.

FIG. 3 is a perspective view illustrating a schematic configuration of an electrode plate manufacturing apparatus according to a first embodiment.

FIG. 4A is a top view of the electrode manufacturing apparatus according to the first embodiment.

FIG. 4B is a side view of the electrode manufacturing apparatus according to the first embodiment.

FIG. 5A is a plan view of a cutting die.

FIG. 5B is a cross-sectional view taken along line B-B′ of FIG. 5A.

FIG. 6A is a plan views illustrating an original plate and a cutting portion in a die cutting process.

FIG. 6B is a plan views illustrating an original plate and a cutting portion in a die cutting process.

FIG. 6C is a plan views illustrating an original plate and a cutting portion in a die cutting process.

FIG. 6D is a plan views illustrating an original plate and a cutting portion in a die cutting process.

FIG. 7A is a cross-sectional view illustrating a process of cutting an original plate.

FIG. 7B is a cross-sectional view illustrating a process of cutting an original plate.

FIG. 7C is a cross-sectional view illustrating a process of cutting an original plate.

FIG. 8A is a plan view of an electrode plate.

FIG. 8B is a plan view of a cutting die according to a first modified embodiment.

FIG. 9 is a plan view of a cutting die according to a second modified embodiment.

FIG. 10A is a plan view of a cutting die according to a third modified embodiment.

FIG. 10B is an explanatory diagram of a force acting on an original plate at the time of cutting.

FIG. 11A is a top view of an electrode manufacturing apparatus according to a fourth modified embodiment.

FIG. 11B is a side view of the electrode manufacturing apparatus according to the fourth modified embodiment.

FIG. 12A is a top view of an electrode manufacturing apparatus according to a fifth modified embodiment.

FIG. 12B is a side view of the electrode manufacturing apparatus according to the fifth modified embodiment.

FIG. 13 is a perspective view illustrating a schematic configuration of an electrode plate manufacturing apparatus according to a second embodiment.

FIG. 14A is a plan development view of a cutting blade.

FIG. 14B is an explanatory diagram illustrating a die-cutting process.

### MODE(S) FOR CARRYING OUT THE INVENTION

Hereinafter, exemplary embodiments of the present invention will be described with reference to the drawings. In the drawings used for description, in order to illustrate characteristic portions in an easily understood manner, a dimension or a scale of components in the drawing may be different from that of actual components. A combination of all components described in embodiments is not necessarily indispensable to the present invention. In embodiments, the same reference numerals are given to the same components, and a detailed description thereof may be omitted. Before describing an electrode plate manufacturing apparatus according to the present invention, a configuration example of a battery cell will be described.

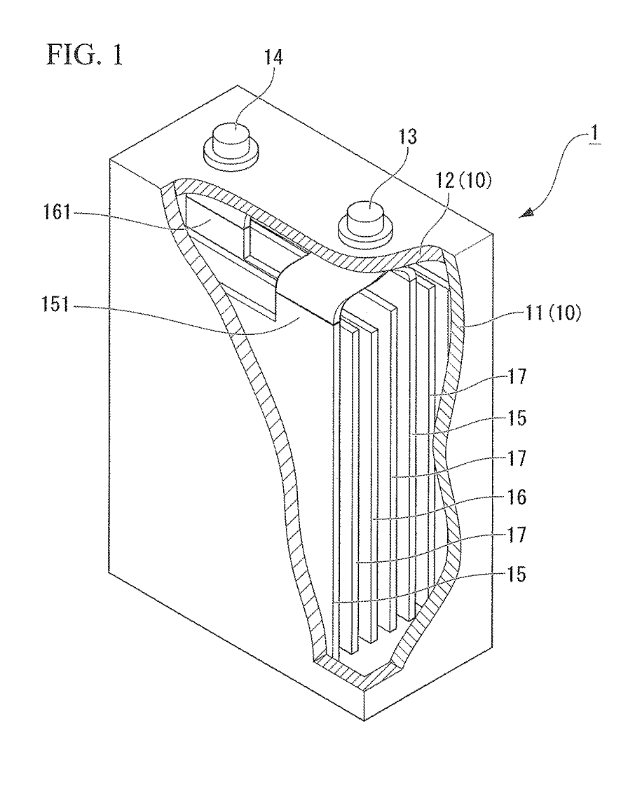

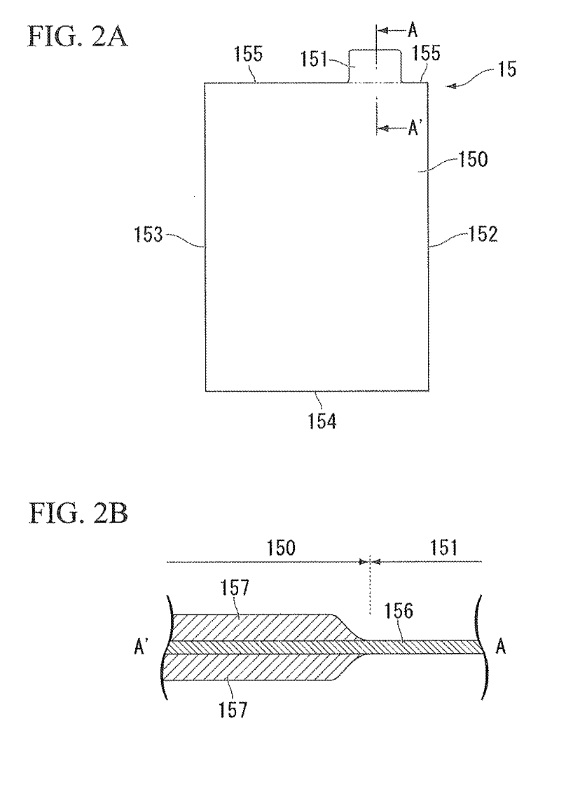

FIG. 1 is an exploded perspective view illustrating a configuration example of a battery cell. FIG. 2A is a plan view illustrating an example of an electrode plate, and FIG. 2B is a cross-sectional view taken along line A-A′ of FIG. 2A.

As illustrated in FIG. 1, a battery cell 1 includes a battery case 10 in which an electrolyte is retained. For example, the battery cell 1 is a lithium-ion secondary battery. An electrode plate manufacturing device according to the present embodiment can be applied to any battery cell whose electrode plate is manufactured by die cutting and thus is not limited to the shape or material of the battery case.

The battery case 10 of the present example is a hollow container made of aluminum and has a substantially prism-like (a substantially rectangular parallelepiped) shape. The battery case 10 includes a case body 11 having an opening and a cover 12 bonded to the case body 11 to close the opening.

Electrode terminals 13 and 14 are disposed on the cover 12. The electrode terminal 13 is a positive terminal, and the electrode terminal 14 is a negative terminal. A plurality of electrode plates 15 and 16 and a plurality of separators 17 are housed inside the battery case 10. The electrode plate 15 is a positive electrode plate, and the electrode plate 16 is a negative electrode plate. The plurality of electrode plates 15 and 16 are repetitively arranged such that the positive electrode plate and the negative electrode plate are alternately lined up. An electrode active material of the electrode plate 15 which is a positive electrode plate is, for example, a ternary-system material (LiNiₓCo_{y}Mn_{z}O₂ (x+y+z=1)), and an electrode active material of the electrode plate 16 which is a negative electrode plate is, for example, a carbon material (e.g., artificial graphite).

The separator 17 is arranged to be sandwiched between a pair of electrode plates 15 and 16 and prevents the electrode plates 15 and 16 from coming in direct contact with each other. The separator 17 is made of a porous insulating material or the like and allows an electrolytic component such as lithium ions to pass therethrough. In fact, a stacked body is formed by stacking a plurality of positive electrode plates, a plurality of negative electrode plates, and a plurality of separators. The battery cell 1 has a structure in which the stacked body is housed in the battery case 10. The electrolyte is retained to come in contact with the electrode plates 15 and 16 inside the battery case 10.

As illustrated in FIG. 2A, the electrode plate 15 includes an electrode body part 150 and an electrode tab 151. The plane shape of the electrode body part 150 is, for example, a substantially rectangular shape and includes a pair of long sides 152 and 153 and a pair of short sides 154 and 155. The electrode tab 151 is formed to have the short side 155 of the electrode body part 150 as a base end and protrude toward the outside of the electrode body part 150.

A direction in which the electrode tab 151 protrudes is substantially orthogonal to the short side 155 and parallel to a main surface of the electrode body part 150. The electrode tab 151 is formed to lean to one side of the short side 155. The electrode tabs 151 of the plurality of electrode plates 15 are collectively electrically connected to the electrode terminal 13.

As illustrated in FIG. 2B, the electrode plate 15 includes a collector 156 and an electrode active material 157. The collector 156 is made of, for example, aluminum or copper and is sheet-like with a thickness of, for example, about tens of micrometers. The electrode active material 157 is made of a formation material depending on the type of an electrolyte and disposed on both surfaces of the collector 156. The thickness of the electrode active material 157 ranges, for example, from about tens of micrometers to hundreds of micrometers.

The electrode plate 15 includes the electrode body part 150 which is coated with the electrode active material 157 and the electrode tab 151 which is not coated with the electrode active material 157. The electrode tab 151 is formed by die-cutting the collector 152 as will be described later.

The electrode plate 16 differs in the formation material of the electrode active material as described above. Although the dimension of the electrode body part is formed to be larger than that of the electrode plate 15, the structure and shape of the electrode body part is same that of the electrode plate 15. As illustrated in FIG. 1, an electrode tab 161 of the electrode plate 16 is arranged not to overlap the electrode tab 151 of the electrode plate 15. The electrode tabs 161 of the plurality of electrode plates 16 are collectively electrically connected to the electrode terminal 14.

### First Embodiment

Next, an electrode plate manufacturing apparatus according to a first embodiment will be described. The electrode plate manufacturing apparatus according to the present invention can be used for manufacturing any of a positive electrode plate and a negative electrode plate, but here an example in which it is applied to the electrode plate 15, which is a positive electrode plate, will be described.

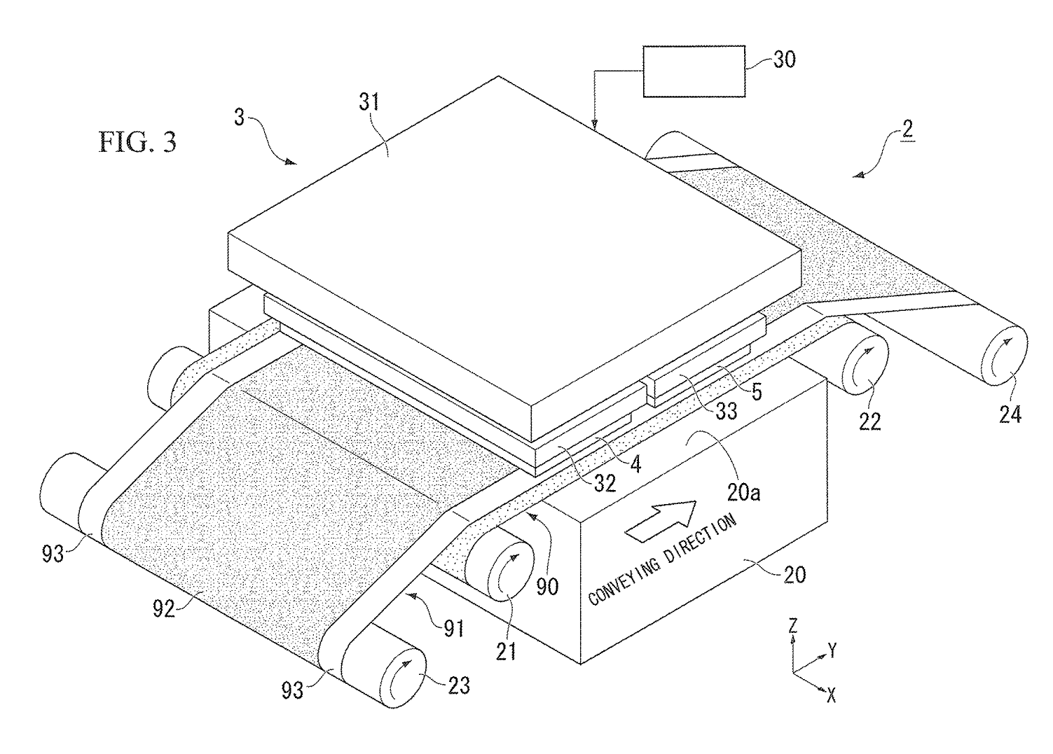

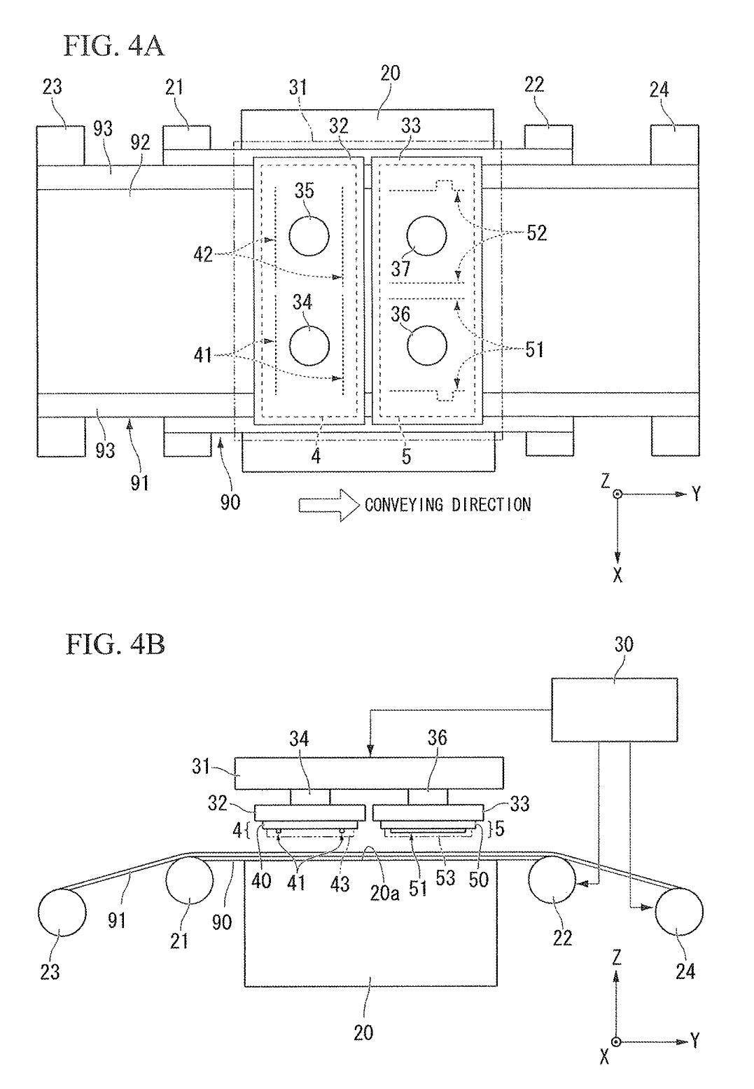

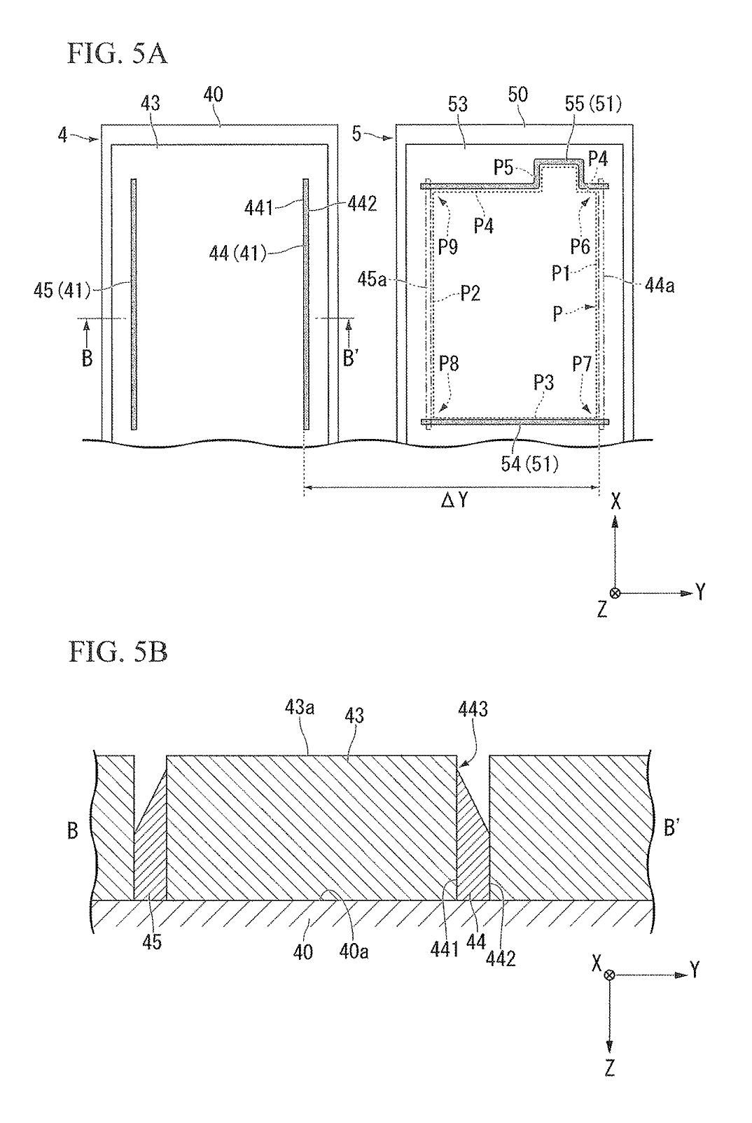

FIG. 3 is a perspective view illustrating a schematic configuration of the electrode plate manufacturing apparatus according to the first embodiment. FIG. 4A is a top view of the electrode plate manufacturing apparatus, and FIG. 4B is a side view of the electrode plate manufacturing apparatus. FIG. 5A is a plan view of a first cutting blade and a second cutting blade when first and second cutting dies are viewed from a surface facing an original plate support portion in a plan view, and FIG. 5B is a cross-sectional view taken along line B-B′ of FIG. 5A.

As illustrated in FIG. 3 and FIGS. 4A and 4B, an electrode plate manufacturing apparatus 2 according to the present embodiment includes an original plate support portion 20, a driving system 3, a first cutting die 4, and a second cutting die 5.

The first cutting die 4 includes a first support substrate 40, and a set of first cutting blades 41 and a set of second cutting blades 42 which are fixed to the first support substrate 40. The two cutting blades are at the same position in a Y direction which is a conveying direction, and aligned and arranged not to overlap each other in an X direction. Specifically, the two cutting blades are disposed at the positions to be line-symmetric to an imaginary line extending from the center of a formation area 92 in the X direction to the Y direction, which is the conveying direction.

The second cutting die 5 includes a second support substrate 50, a set of third cutting blades 51 which are fixed to the second support substrate 50 and correspond to the first cutting blades 41, and a set of fourth cutting blades 52 which are fixed to the second support substrate 50 and correspond to the second cutting blades. The two cutting blades are at the same position in the Y direction, and aligned and arranged at the positions respectively corresponding to the cutting blades of the first cutting die 4 in the X direction. Specifically, the two cutting blades are disposed at the positions to be line-symmetric to an imaginary line extending from the center of the formation area 92 in the X direction to the Y direction, which is the conveying direction.

A combination of the shape of the first cutting blade 41 and the shape of the third cutting blade 51 corresponding thereto becomes the shape of the electrode plate. Similarly, a combination of the shape of the second cutting blade 42 and the shape of the fourth blade 52 corresponding thereto becomes the shape of the electrode plate. That is, the two electrode plates 15 having the same shape can be formed at the same time by the first cutting die 4 and the second cutting die 5.

The first to fourth cutting blades are configured with, for example, a Thomson cutter.

As described later, a first pressing portion 43 covering the periphery of the first and second cutting blades is disposed on the first cutting die 4, and a second pressing portion 53 covering the periphery of the third and fourth cutting blades is disposed on the second cutting die 5.

The driving system 3 is configured with conveying rollers 21 to 24 as a conveying, a control portion 30, a driving portion 31, and holding portions 32 and 33.

The components of the electrode plate manufacturing apparatus 2 are arranged as follows.

The conveying rollers 21 and 22 are disposed to sandwich the original plate support portion 20 in the Y direction so as to convey a protection sheet 90 along a planar upper surface 20a of the original plate support portion 20. The conveying rollers 23 and 24 are disposed to sandwich the original plate support portion 20 and the conveying rollers 21 and 22 in the Y direction so as to convey an original plate 91 arranged on the protection sheet 90 on the upper surface 20a in the Y direction similarly to the protection sheet 90. Here, the Y direction is a direction in which the conveying rollers 21 to 24 convey the original plate 91 or the die-cut electrode plate.

As illustrated in FIG. 4B, the conveying rollers 23 and 24 for conveying the original plate 91 are arranged at positions (−Z direction) lower than the conveying rollers 21 and 22 for conveying the protection sheet 90. The conveying rollers arranged in the above described manner cause a tensile force to act on the original plate 91, and thus the original plate 91 can be prevented from crinkling. Therefore, it is possible to appropriately perform die-cutting of the electrode plate.

For example, the protection sheet 90 is made of a resin sheet. When the cutting blade penetrates and cuts the original plate 91, the protection sheet 90 prevents the cutting blades from touching the upper surface 20a of the original plate support portion 20, that is, the cutting blades from getting damaged.

The driving portion 31 is disposed above (+Z direction) the original plate support portion 20. Support posts 34 to 37 in which one ends thereof are arranged on the same plane and which perform up-down movement by the driving portion 31 are connected to the driving portion 31. The holding portion 32 is connected to the other ends of the support posts 34 and 35, and the holding portion 33 is connected to the other ends of the support posts 36 and 37.

The first cutting die 4 is attached to a lower surface side of the holding portion 32, and the second cutting die 5 is attached to a lower surface side of the holding portion 33.

Here, the holding portion 32 and the holding portion 33 are described as separate configurations, the holding portion 32 and the holding portion 33 may be combined as one holding portion.

A schematic operation of the electrode plate manufacturing apparatus 2 is as follows.

The control portion 30 controls an operation of the conveying rollers 21 to 24 and the driving portion 31. First, the control portion 30 conveys the original plate 91 and the protection sheet 90, which are synchronized with each other, by a predetermined interval and then stops the conveying rollers 21 to 24. That is, the control portion 30 controls the conveying rollers 21 to 24 which intermittently perform an operation.

The predetermined interval refers to a distance from a midpoint between the set of first cutting blades 41 in the Y direction and a midpoint between the set of third cutting blades 51 in the Y direction.

After the conveying rollers 21 to 24 stop, the control portion 30 controls the driving portion 31 such that the holding portions 32 and 33 moves downward (−Z direction). Thus, the first cutting die 4 and the second cutting die 5 move toward the upper surface 20a of the original plate support portion 20 and press the original plate 91 conveyed onto the upper surface 20a. The first to fourth cutting blades 41, 42, 51, and 52 cut the original plate 91, and thus a first cutting portion by the first cutting die 4 and a second cutting portion by the second cutting die 5 are formed in the original plate 91.

At this time, die cutting of the electrode plate 15 is completed when the second cutting portion is formed.

After the first cutting portion and the second cutting portion are formed, the holding portions 32 and 33 move upward (+Z direction), and thus the first cutting die 4 and the second cutting die 5 retreat from the original plate 91, that is, withdraw upward. After the withdrawal, the control portion 30 controls the conveying rollers 21 to 24 such that the original plate 91 and the protection sheet 90 are conveyed the predetermined distance, and thus the conveying rollers 21 to 24 stop.

After the stopping, the control portion 30 controls the driving portion 31 such that the first cutting die 4 and the second cutting die 5 move toward the upper surface 20a of the original plate support portion 20 again. As a result of the conveyance, the first cutting portion is positioned directly below the second cutting die. Thus, by re-movement of the original plate support portion 20, the first cutting portion and the second cutting portion are joined together, and portions surrounded by the first cutting portion and the second cutting portion are die-cut from the original plate 91 as the two electrode plates 15.

The electrode plate manufacturing apparatus 2 repeats the above operation and repetitively die cuts the original plate 91.

As illustrated in FIG. 4A, the formation area 92 in which the electrode active material is provided on both surfaces of the collector and a non-formation area 93 in which the electrode active material is not provided are disposed on the collector. The non-formation area 93 is formed at both ends of the original plate 91 in a width direction (X direction).

An electrode tab of one electrode plate is die-cut from the non-formation area 93 at one end of the original plate 91, and an electrode tab of another electrode plate is die-cut from the non-formation area 93 at the other end. That is, as described above, the third cutting blade 51 and the fourth cutting blade 52 are arranged so that a total of two electrode plates with the electrode tabs can be simultaneously die cut.

As illustrated in FIG. 5A, the first cutting blade 41 includes a first blade element 44 and a second blade element 45. The first blade element 44 refers to a portion that forms the long side 152 of the electrode plate 15 illustrated in FIG. 2A by cutting the original plate 91. The second blade element 45 refers to a portion that forms the long side 153. As illustrated in FIG. 5B, the first pressing portion 43 comes in contact with one surface 441 and the other surface 442 of the first blade element 44 and one surface and the other surface of the second blade element 45, is fixed to an arrangement surface 40a of the first support substrate 40, and surrounds the first blade element 44 and the second blade element 45.

The second cutting blade 42 also has the same configuration.

The third cutting blade 51 includes a third blade element 54 and a fourth blade element 55. The third blade element 54 refers to a portion that forms the short side 154. The fourth blade element 55 refers to a portion that forms the short side 155 and the electrode tab 151. Similarly to FIG. 5B, the second pressing portion 53 comes in contact with one surface and the other surface of the third blade element 54 and one surface and the other surface of the fourth blade element 55, is fixed to an arrangement surface of the second support substrate 50, and surrounds the third blade element 54 and the fourth blade element 55.

The fourth cutting blade 52 also has the same configuration.

The first to fourth blade elements 44, 45, 54, and 55 are independent of one another, and are all configured with a single-edged band-like body. For example, the plate thickness of the band-like body ranges from about 0.5 mm to 2.0 mm. On the band-like body, a blade edge is disposed along one side in the width direction. The band-like body is attached to the first support substrate 40 and the second support substrate 50 so that the width direction can be substantially vertical to the facing surface.

The first pressing portion 43 and the second pressing portion 53 are members that press the original plate 91 toward the original plate support portion 20 when the original plate 91 is die-cut. For example, the first pressing portion 43 and the second pressing portion 53 are configured of an elastic body such as rubber or sponge.

In the first pressing portion 43, a dimension (thickness) of the facing surface 40a in a normal direction is set so that a surface 43a can protrude toward the original plate support portion 20 further than a blade edge 443. As the pressing portion, any member capable of pressing the original plate 91 toward the original plate support portion 20 can be used. For example, a member having a pressing surface may be biased toward the original plate support portion 20 by a spring or the like. Further, the pressing portion may be supported by another member different from the support member of the first and second cutting blades. This is similarly applied to the second pressing portion 53.

The first cutting blade 41 and the third cutting blade 51 are arranged to satisfy the following condition. Here, the first blade element 44 imaginarily parallel-shifted in the conveying direction (Y direction) by a predetermined distance ΔY is referred to as a first imaginary blade element 44a. Similarly, the second blade element 45 imaginarily parallel-shifted in the conveying direction by a predetermined distance AY is referred to as a second imaginary blade element 45a. That is, in a state in which the facing surface of the second support substrate 50 is viewed in a plan view, the first imaginary blade element 44a intersects with the third and fourth blade elements 54 and 55, and the second imaginary blade element 45a intersects with the third and fourth blade elements 54 and 55.

The first imaginary blade element 44a and the second imaginary blade element 45a may intersect so as to overlap the end portion of the third blade element 54 and the end portion of the fourth blade element 55 portion or may intersect with the third blade element 54 and the fourth blade element 55 at an inner side of the end portion. Here, both of the first imaginary blade element 44a and the second imaginary blade element 45a intersect with the third blade element 54 and the fourth blade element 55.

A portion surrounded by the first imaginary blade element 44a, the second imaginary blade element 45a, the third blade element 54, and the fourth blade element 55 has an electrode plate shape P. The original plate is die-cut in the electrode plate shape P, and thus the electrode plate 15 of FIG. 2A is formed.

Thus, an outline of the electrode plate 15 illustrated in FIG. 2A substantially matches the electrode plate shape P. The electrode plate shape P includes first extension portions P1 and P2, second extension portions P3 and P4, a tab forming portion P5, and first to fourth corner portions P6 to P9.

The first extension portion P1 extends from the first corner portion P6 in a first direction (the X direction), and the second extension portion P4 extends in a second direction (the Y direction) to intersect with the first extension portion P1 at the first corner portion P6.

The first extension portion P1 extends from the second corner portion P7 in the first direction, and the second extension portion P3 extends in the second direction to intersect with the first extension portion P1 at the second corner portion P7.

The first extension portion P2 extends from the third corner portion P8 in the first direction, and the second extension portion P3 extends in the second direction to intersect with the first extension portion P2 at the third corner portion P8.

The first extension portion P2 extends from the fourth corner portion P9 in the first direction, and the second extension portion P4 extends in the second direction to intersect with the first extension portion P2 at the fourth corner portion P9.

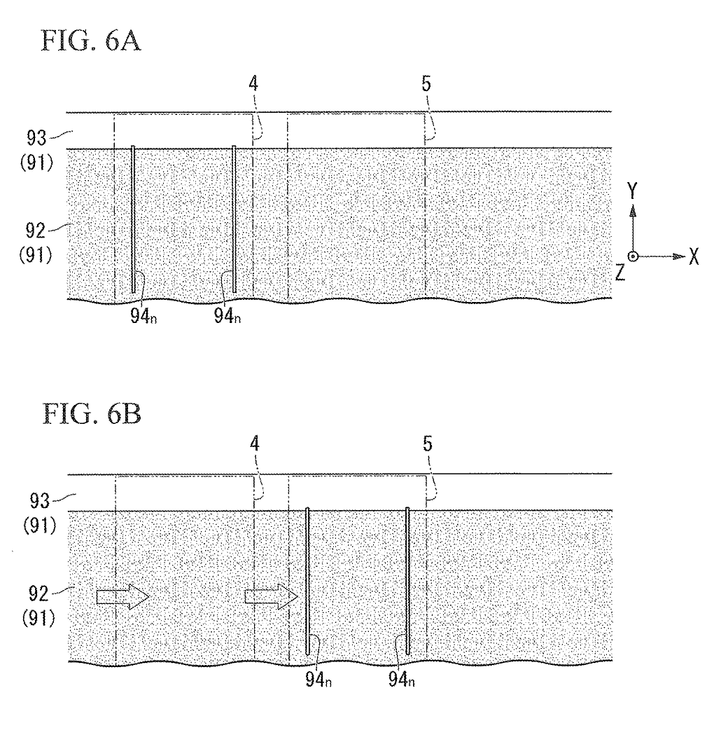

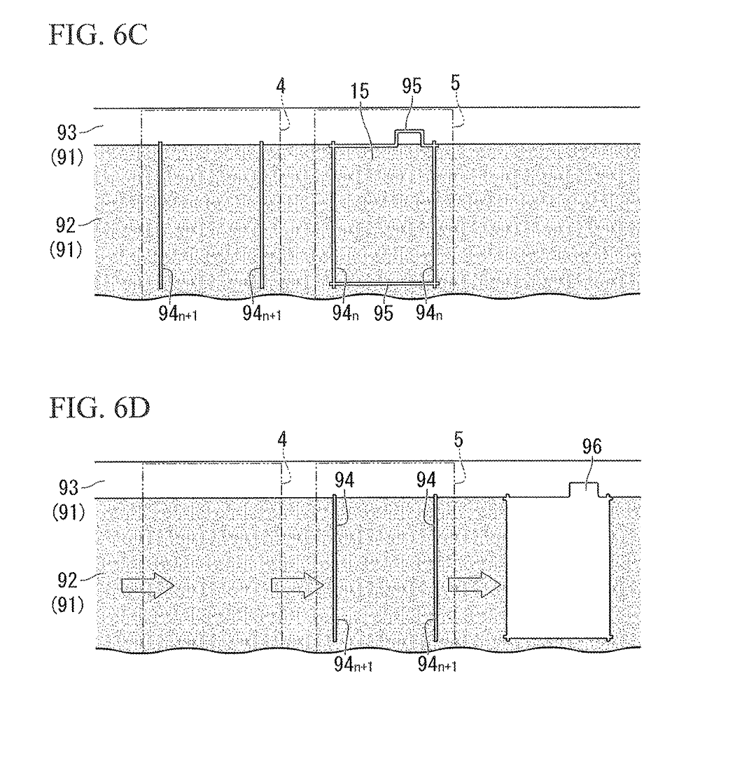

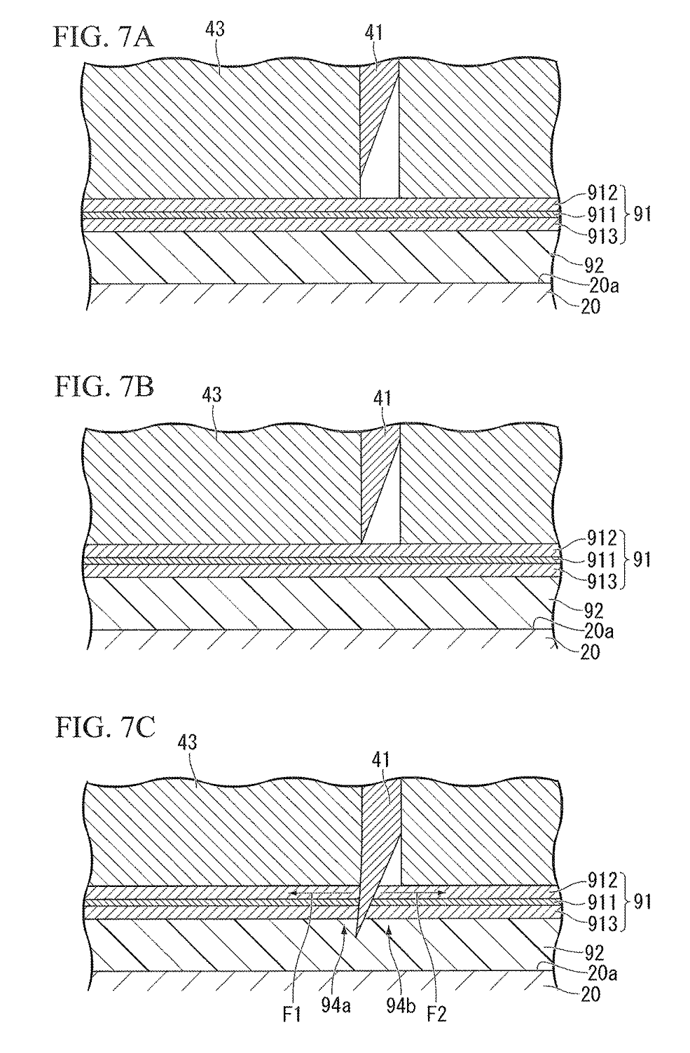

FIGS. 6A to 6D are plan views illustrating an original plate and a cutting portion in a die cutting process. FIGS. 7A to 7C are cross-sectional views illustrating a process of cutting an original plate. In FIGS. 6A to 6D, one side is illustrated with respect to a central line imaginarily extending in the Y direction from the center of the formation area 92 of the original plate 91 in the X direction, but similar die-cutting is performed at substantially the same time on the other side which is not shown. Further, in FIGS. 7A to 7C, a state in which the original plate 91 is cut by the first cutting die 4 is illustrated, but a cutting state by the second cutting die 5 is also similar.

In the die-cutting process, when the conveying rollers 21 to 24 stop, first, the first cutting die 4 presses the original plate 91. Thus, the second cutting die 5 presses the original plate 91 together with the first cutting die 4. As illustrated in FIG. 6A, a first cutting portion 94ₙ is formed in a first pattern corresponding to the first cutting blade 41.

As illustrated in FIG. 7A, when the first cutting die 4 comes in contact with the original plate 91, first, the first pressing portion 43 comes in contact with the surface (the electrode active material 912) of the original plate 91. In this stage, the blade edge does not come in contact with the electrode active material 912 positioned on one surface of the original plate 91.

Then, when the first cutting die 4 further moves downward, as illustrated in FIG. 7B, the first pressing portion 43 is pressed toward the original plate support portion 20 and compression-deformed, and the blade edge comes in contact with the original plate 91. A pressing force of the first pressing member 43 causes the original plate 91 to be pressed toward the original plate support portion 20, and thus positional deviation between the original plate 91 and the first cutting blade 41 is prevented.

Then, when the first cutting die 4 further moves downward, as illustrated in FIG. 7C, the blade edge protrudes toward the original plate support portion 20 further than the first pressing portion 43 and enters the original plate 91. With the downward movement of the first cutting die 4, the blade edge penetrates the electrode active material 912, a collector 911, and the electrode active material 913 positioned at the other surface layer of the original plate 91, so that the original plate 91 is cut. After the original plate 91 is cut, when the first cutting die 4 moves upward, the original plate 91 is separated from the first cutting blade 41 in a state in which the pressing force of the pressing portion 43 is maintained. Thus, the original plate 91 is prevented from moving together with the first cutting blade 41.

Next, the original plate 91 in which the first cutting portion 94ₙ has been formed is conveyed downstream in the conveying direction (the Y direction) by a predetermined distance ΔY (see FIG. 5A) as illustrated in FIG. 6B. A portion in which the first cutting portion 94ₙ is formed faces the second cutting die 5.

Next, the first cutting die 4 and the second cutting die 5 press the original plate 91 again. A new first cutting portion 94ₙ₊₁ is formed in the original plate 91 below the first cutting die 4. Further, a second cutting portion 95 which has a second pattern corresponding to the second cutting blade 51 is formed in the original plate below the second cutting die 5. The second cutting portion 95 is formed to intersect with the first cutting portion 94ₙ, and a portion surrounded by the first cutting portion 94ₙ and the second cutting portion 95 is die-cut from the original plate 91 as the electrode plate 15.

Next, the original plate 91 is conveyed downstream in the conveying direction (the Y direction) by a predetermined distance ΔY (see FIG. 5A) as illustrated in FIG. 6D. Thus, the new first cutting portion 94ₙ₊₁ formed together with the second cutting portion 95 is conveyed to the position below the second cutting die 5. Then, by repeating the processes illustrated in FIGS. 6C and 6D, the electrode plate die-cutting apparatus 2 repetitively die-cuts the original plate 91.

The die-cut electrode plate 15 is separated from the original plate 91 by a separation means (not shown) after the first cutting die 4 and the second cutting die 5 move away from the original plate 91. After the separation, a void portion 96 is formed in the original plate.

Meanwhile, as illustrated in FIG. 7C, when the first cutting blade 41 enters the original plate 91, an end portion 94a including one cutting surface of the original plate 91 and an end portion 94b including the other cutting surface are expanded, in opposite directions, by the thickness of the first cutting blade 41 of the entered portion. Thus, a compression force F1 acts on the end portion 94a in a direction parallel to the main surface of the original plate 91, and a compression force F2 acts on the end portion 94b in a direction reverse to the compression force F1. Even when the second cutting blade 51 enters the original plate 91, for the same reason, a compression force acts on the original plate near the cutting portion.

In the electrode plate manufacturing apparatus disclosed in Patent Document 1, the original plate is almost simultaneously cut all around the cutting blade, and a portion, which becomes a corner of the electrode plate (also referred to as a “corner portion”), almost simultaneously receives a compression force from two sides connected to the corner portion. When the compression force is above a certain value, since the collector and the electrode active material differ in material and in mechanical characteristics from each other, the collector and the electrode active material are not deformed at the same time. In this case, a shear force acts in a direction parallel to an interface between the collector and the electrode active material (hereinafter referred to simply as an “interface”), and thus adhesion between the collector and the electrode active material is lowered.

In the electrode plate die-cutting apparatus 2 according to the first embodiment, the first pattern by the first cutting die 4 and the second pattern by the second cutting die 5 are formed at different timings, and a portion in which the first pattern and the second pattern intersect with each other becomes the corner portion of the electrode plate 15. Thus, a maximum value of a compression force acting on the corner portion of the electrode plate 15 at a time is lowered, and adhesion between the collector 911 and the electrode active materials 912 and 913 at the corner portion of the electrode plate 15 is prevented from being lowered. Thus, during or after die-cutting, the electrode active material is not easily separated from the collector at the corner portion of the electrode plate 15.

Since the first cutting blade 41 and the third cutting blade 51 are arranged so that the first pattern can intersect with the second pattern, even if positional deviation has occurred in the original plate 91, a problem in which the first pattern is not connected with the second pattern is prevented. Further, both end portions of the first cutting blade 41 in the extending direction are positioned outside the portion which becomes the electrode plate 15, and the both end portions of the third cutting blade 51 in the extending direction are positioned outside the portion which becomes the electrode plate 15. Thus, even if portions cut by both ends portions of the first cutting blade 41 and the second cutting blade 51 have been distorted, this distortion does not have a bad influence on the electrode plate 15.

This point is similarly applied to a relation between the second cutting blade 42 and the fourth cutting blade 52.

The first cutting blade 41 and the third cutting blade 51 are configured with a single-edged blade in which an edge blade leans to the surface side which forms the contour of the electrode plate shape P. Thus, a portion surrounded by the first pattern and the second pattern, that is, a portion which becomes the electrode plate 15, is smaller in displacement of the cutting surface than the outside of the portion. As a result, a compression force acting on the portion which becomes the electrode plate 15 is reduced, and separation of the electrode active material in the electrode plate 15 is reduced.

As described above, according to the electrode plate manufacturing apparatus 2 according to the first embodiment, separation of the electrode active material can be reduced. Thus, it is possible to prevent battery performance from being lowered due to a reduction in the amount of electrode active material of the electrode plate portion, and a high-performance battery cell can be configured. Further, exposure of the collector caused by peeling of the electrode active material is prevented, and a short circuit caused by exposure of the collector is avoided. Thus, a battery cell in which few problems occur can be formed.

Further, a technical scope of the present invention is not limited to the above embodiment. Various modifications can be made in a range not departing from the gist of the present invention. For example, modifications which will be described below are conceivable.

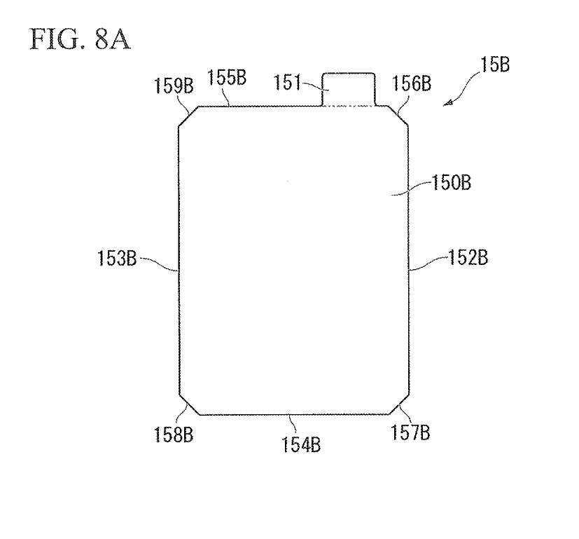

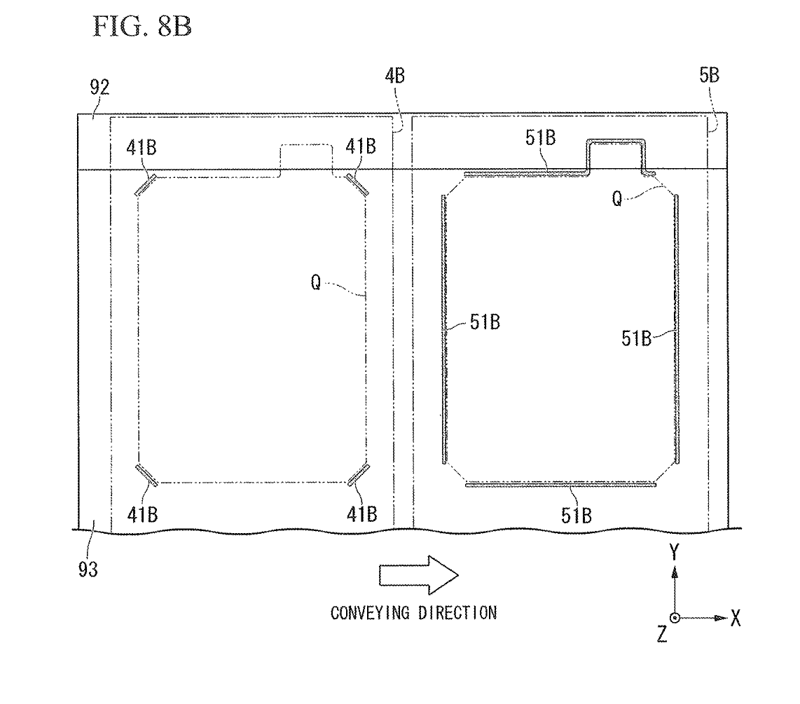

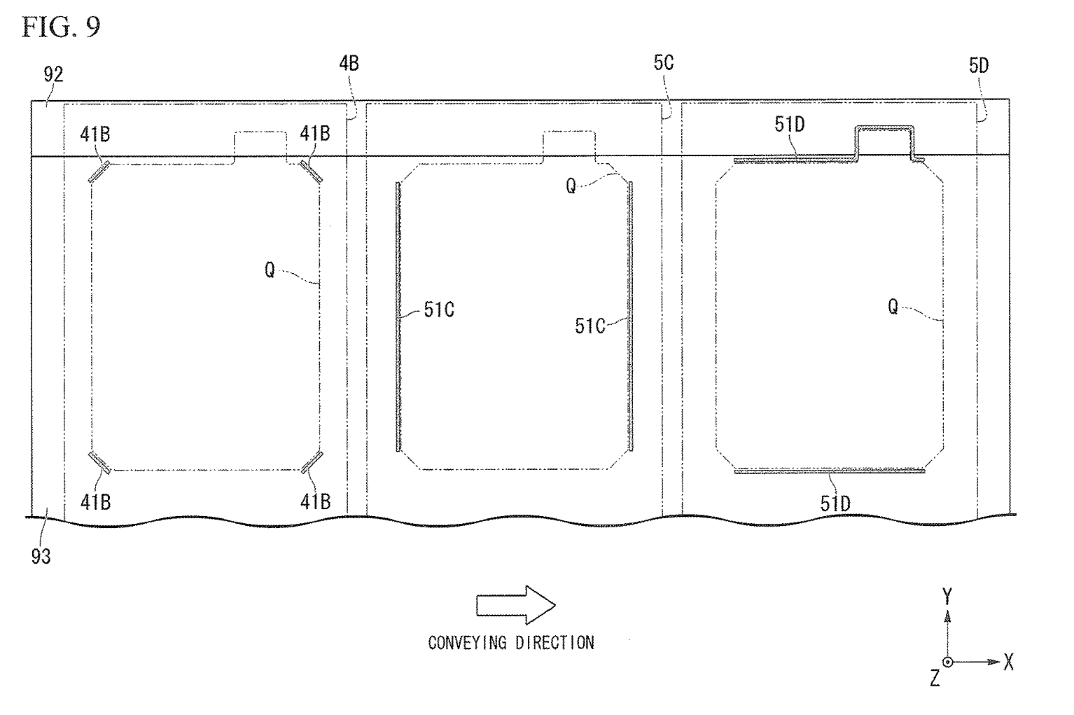

FIG. 8A is a plan view illustrating an example of an electrode plate die-cut by an electrode plate manufacturing apparatus according to a first modified embodiment. FIG. 8B is a plan view illustrating first and second cutting dies according to the first modified embodiment. As illustrated in FIG. 8A, an electrode plate 15B includes an electrode body portion 150B and an electrode tab 151.

The electrode body portion 150B has a substantially octagonal shape in which corners of a rectangle are removed when seen in a plan view, and all inner angles are obtuse angles.

Specifically, the electrode body portion 150B includes sides 152B to 159B. The sides 152B and 153B extend in a first direction (the Y direction). The sides 154B and 155B extend in a second direction (the X direction) substantially orthogonal to the first direction. The side 156B is connected to the side 155B and the side 152B near a base end of the electrode tab 151. The side 157B is connected to the side 152B and the side 154B. The side 158B is connected to the side 153B and the side 154B. The side 159B is connected to the side 153B and the side 155B.

As illustrated in FIG. 8B, in the first cutting die 4B, a first cutting blade 41B is disposed so that blade edges are distributed in portions corresponding to the side 156B to the side 159B, in an electrode plate shape Q corresponding to a contour of the electrode plate 15. Further, in the second cutting die 5B, a second cutting blade 51B is disposed so that blade edges are distributed in portions corresponding to an outer periphery of the electrode tab 151 and the side 152B to the side 155B, in the electrode plate shape Q.

If the first cutting blade 41B is imaginarily parallel-shifted in the conveying direction by a predetermined distance to overlap the second cutting blade 51B, a first imaginary cutting blade and the second cutting blade 51B are joined, so that blade edges are distributed along the electrode plate shape Q. The electrode plate manufacturing apparatus according to the first modified embodiment is the same in configuration of portions except for the first cutting die 4B and the second cutting die 5B as in the first embodiment.

According to the electrode plate manufacturing apparatus according to the first modified embodiment, since the inner angles of the corner portions of the electrode body portion 150B are obtuse angles, the die-cut electrode plate 15B does not have separation of the electrode active material occurring at the corner portion. The electrode plate 15B may be die-cut by an electrode plate manufacturing apparatus according to a second modified embodiment, which will be described next.

FIG. 9 is a plan view illustrating a cutting die of the electrode plate manufacturing apparatus according to the second modified embodiment. In the second modified embodiment, the four blades 51B in the second cutting die 5B of the first modified embodiment are divided by two pieces, and thus cutting dies 5C and 5D are disposed. That is, first to third cutting dies 4B, 5C, and 5D are disposed.

In the second cutting die 5C, a third cutting blade 51C is disposed to correspond to the sides 152B and 153B in the electrode plate shape Q. In the third cutting die 5D, a fourth cutting blade 51D is disposed to correspond to the sides 154B and 155B and the outer periphery of the electrode tab 151 in the electrode plate shape Q.

If the second cutting blade 51 C is imaginarily parallel-shifted in the conveying direction by a predetermined distance, and the first cutting blade 41B is imaginarily parallel-shifted in the conveying direction by two times a predetermined distance, they are joined, so that blade edges are distributed along the electrode plate shape Q.

The present invention is not limited to the three cutting dies and the patterns of the cutting blades illustrated in FIG. 9. In the case of a configuration of sequentially cutting corner portions (a corner formed by the side 152B and the side 156B, a corner formed by the side 152B and the side 157B, a corner formed by the side 154B and the side 157B, a corner formed by the side 154B and the side 158B, a corner formed by the side 153B and the side 158B, a corner formed by the side 153B and the side 159B, a corner formed by the side 155B and the side 159B, and a corner formed by the side 155B and the side 156B) of the electrode shape Q by multi-stage cutting as described above, the number of cutting dies and the patterns of the cutting blades may not be limited.

Further, the outer periphery of the electrode tab and the side 155B in the electrode plate shape Q configure a connected cutting blade. However, in order to prevent separation of the electrode active material of corresponding portions and manufacture the electrode plate with a higher degree of accuracy, the outer periphery of the electrode tab and the side 155B may configure cutting blades respectively corresponding to separate cutting dies.

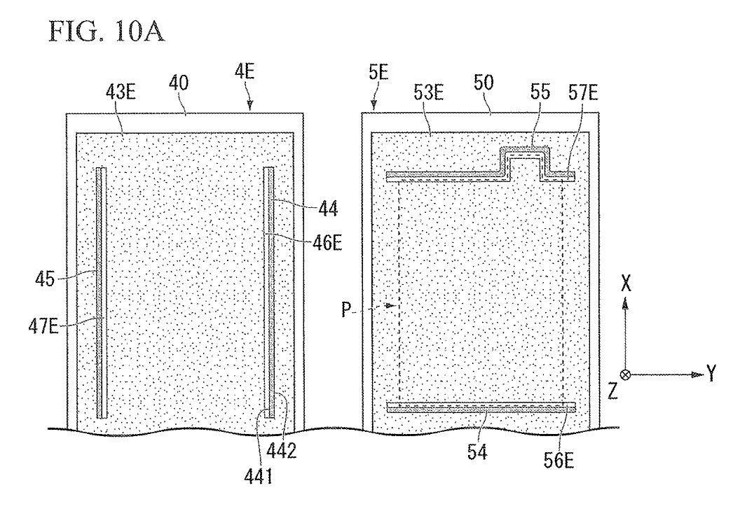

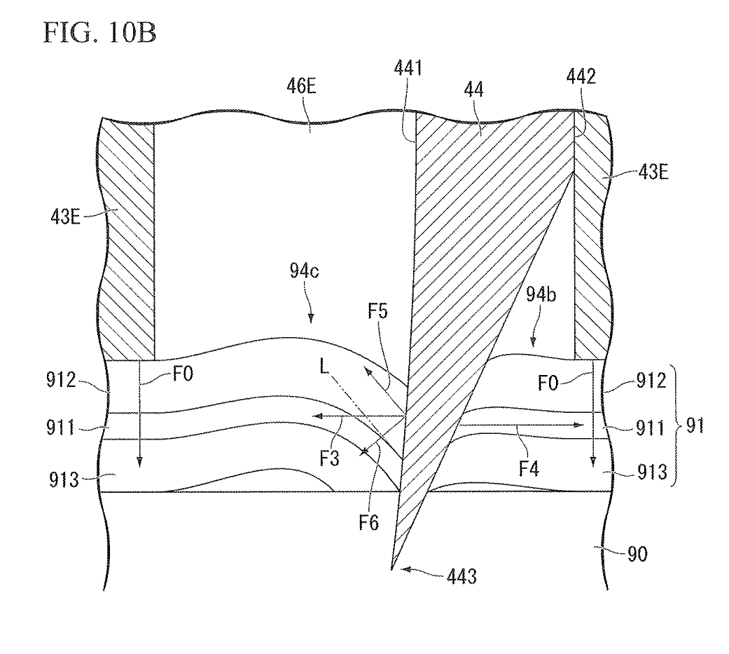

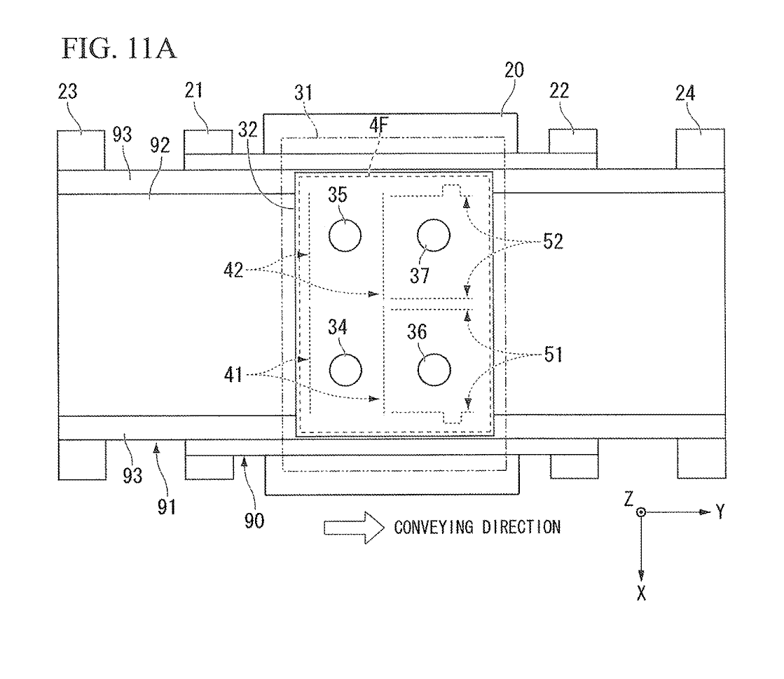

FIG. 10A is a plan view illustrating a cutting die of an electrode plate manufacturing apparatus according to a third modified embodiment. FIG. 10B is an explanatory diagram illustrating a force acting on the original plate at the time of cutting. As shown in FIG. 10A, the third modified embodiment is different from the first embodiment in that notches are formed in a first pressing portion and a second pressing portion, and voids are formed between a portion that forms a part of the electrode plate shape P and the first and second pressing portions on each of first to fourth blade elements.

In the third modified embodiment, a first cutting die 4E is configured such that a first blade element 44 and a second blade element 45 that constitute a first cutting blade and a first pressing portion 43E are disposed on a facing surface of a first support substrate 40. A notch 46E is disposed in a portion along the one surface 441 at a side of the first blade element 44 facing the second blade element 45. Since the notch 46E is disposed, this one surface 441 is apart from the first pressing portion 43E. In the present example, the other surface 442, which is a back surface of the one surface 441, comes in contact with the first pressing portion 43E. The notch 47E is disposed in a portion along one surface at a side of the second blade element 45 facing the first blade element 44. This one surface is apart from the first pressing portion 43E.

A second cutting die 5E is configured such that third and fourth blade elements 54 and 55 that constitute a second cutting blade and a second pressing portion 53E are disposed on one surface of a second support substrate 40. A notch 56E is disposed in a portion along one surface at a side of the third blade element 54 facing the fourth blade element 55. This one surface is apart from the second pressing portion 53E. The notch 57E is disposed in a portion along one surface at a side of the fourth blade element 55 facing the third blade element 54. This one surface is apart from the second pressing portion 53E.

When the electrode plate 15 is die-cut from the original plate 91 by the electrode plate manufacturing apparatus including the first cutting die 4E and the second cutting die 5E configured in the above described manner, as will be described later, an effect of reducing separation of the electrode active material can increase. Here, while the above description has been made in connection with the vicinity of the cutting portion by the first blade element 44, the present embodiment is similarly applied to the vicinities of the cutting portions by the second to fourth blade elements 45, 54, and 55.

As illustrated in FIG. 10B, in a portion of the original plate 91 which comes in contact with the first pressing portion 43E, a position pressed by a pressing force F0 of the first pressing portion 43E is restricted. The end portion 94b of the original plate 91 including a cutting surface at a side contacting the other surface 442 receives a compression force F4, which is applied toward the outside of the first blade element 44 by the entrance of the blade edge 443 of the first blade element 44, from the other surface 442 and compressed in a direction parallel to the main surface of the original plate 91.

In the end portion 94b, as the position of a portion coming in contact with the first pressing portion 43E is restricted, a range deformable in a direction parallel to the main surface of the original plate 91 is confined. Since distortion of the end portion 94b is difficult to mitigate, the compression force F4 intensively acts on the end portion 94b. Since the deformable range is confined, the end portion 94b is not easily deformed by bending. Thus, the compression force F4 acts on in a direction substantially parallel to the interface, and most of the compression force F4 contributes to generating a shear force which causes deviation of the collector 911 and the electrode active materials 912 and 913. However, since the end portion 94b is a portion that does not become the electrode plate, even if the electrode active material exfoliated from the end portion 94b, few problems occur.

In the original plate 91, an end portion 94c including a cutting portion at a side coming in contact with the one surface 441 is a portion which becomes the electrode plate. The end portion 94c receives a compression force F3 reverse to the compression force F4 from the one surface 441 and compressed in the normal direction of the one surface 441. As the notch 46E is disposed, the end portion 94c includes a portion, which is not pressed against the first pressing portion 43E, between a portion pressed against the first pressing portion 43E and a portion coming in contact with one surface 441. Since the end portion 94c has a deformable range wider than the end portion 94b, the end portion 94c is small in compression stress acting thereon and is easily deformed by bending. As bending deformation (an angle of deflection) of the end portion 94c increases, a tangential line L of the interface at which the end portion 94c comes in contact with the one surface 441 is more inclined with respect to a normal direction of the one surface 441.

The compression force F3 may be split into a component force F5 parallel to the tangential line L and a component force F6 vertical to the tangential line L. The component force F5 is a force which deviates the current collecting material 911 and the electrode active materials 912 and 913 similarly to the shear force. The component force F6 is a force which causes the collector 911 and the electrode active materials 912 and 913 to approach each other in a portion coming in contact with the one surface 441. That is, the component force F6 acts to cause the collector 911 and the electrode active materials 912 and 913 to adhere to each other.

As the inclination of the tangential line L to the direction parallel to the main surface of the original plate 91 increases, the ratio of the component force F6 to the component force F5 increases. That is, as the inclination of the tangential line L increases, the shear force that exfoliates the current collecting material 911 and the electrode active materials 912 and 913 decreases, and a force that causes the electrode active material 912 and 913 to adhere to the current collecting material 911 increases. That is, by making the inclination of the tangential line L equal to or larger than a predetermined value, an effect of increasing an adhesion force by the component force F6 can be more excellent than an effect of reducing an adhesion force by the component force F5.

In the third modified embodiment, an interval between the one surface 441 and the first pressing portion 43E, that is, a dimension of the notch 46E is set to allow the end portion 94c to be bent so that an adhesion force can be secured to the extent that the current collecting material 911 and the electrode active materials 912 and 913 are not exfoliated.

On the dimension of the notch, an interval between the pressing portion and the cutting blade is preferably set to 1 mm or more, and when the interval is set to 2 mm or more, an effect of reducing exfoliation of the electrode active material may increase. In the process of die cutting, from a point of view for reducing positional deviation between the original plate and the cutting blade, the interval is preferably 10 mm or less, and when the interval is 5 mm or less, an effect of reducing positional deviation may increase. As described above, the interval is preferably 1 mm or more and 10 mm or less, and more preferably, 2 mm or more and 5 mm or less.

The electrode plate manufacturing apparatus according to the third modified embodiment not only can prevent separation of the electrode active material at the corner of the electrode plate but also can prevent separation of the electrode active material when the original plate is cut through the straight line-like cutting blades.

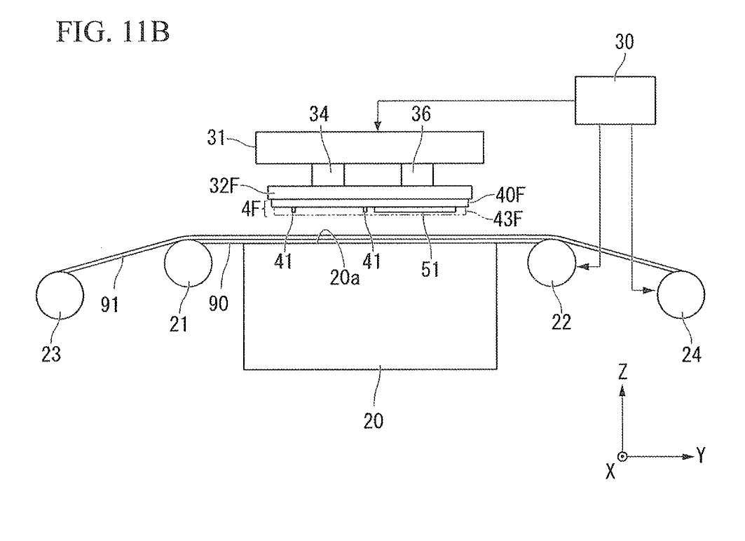

FIG. 11A is a top view illustrating an electrode plate manufacturing apparatus according to a fourth modified embodiment, and FIG. 11B is a side view of the electrode plate manufacturing apparatus according to the fourth modified embodiment. As illustrated in FIGS. 11A and 11B, a cutting die 4F of the electrode plate manufacturing apparatus according to the fourth modified embodiment is held by a holding portion 32F. The holding portion 32F is supported by the support posts 34 to 37. The cutting die 4F has a structure in which first and second cutting blades 41 and 51 and a pressing portion 43F are disposed on a facing surface of a support substrate 40F. As described above, in the fourth modified embodiment, the first cutting blade 41 and the second cutting blade 51 are disposed on the same support substrate.

In the cutting die 4F having the above described structure, unlike the configuration in which the first cutting blade 41 and the second cutting blade 51 are disposed on the different support substrates, respectively, clearance between a plurality of support substrates need not be secured, and thus the first and second cutting blades 41 and 42 can be arranged to be close to the third and four cutting blades 51 and 52. Thus, the device size can be reduced.

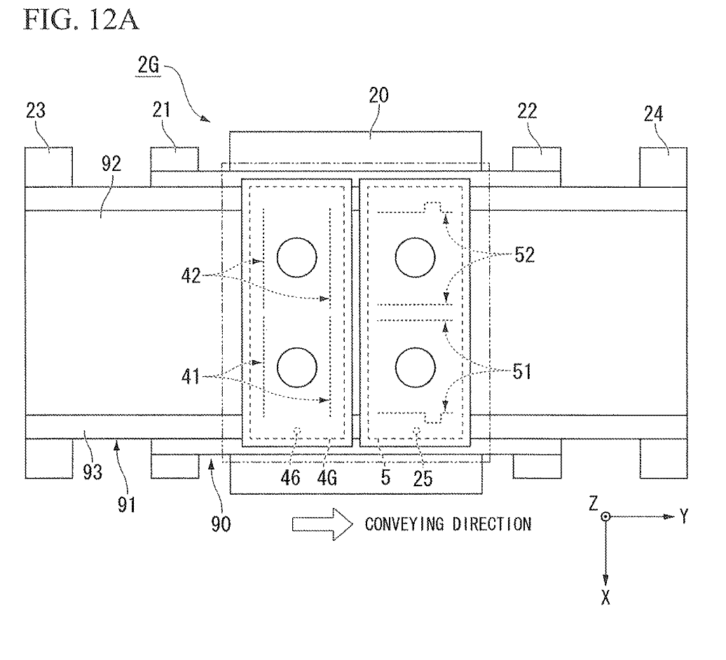

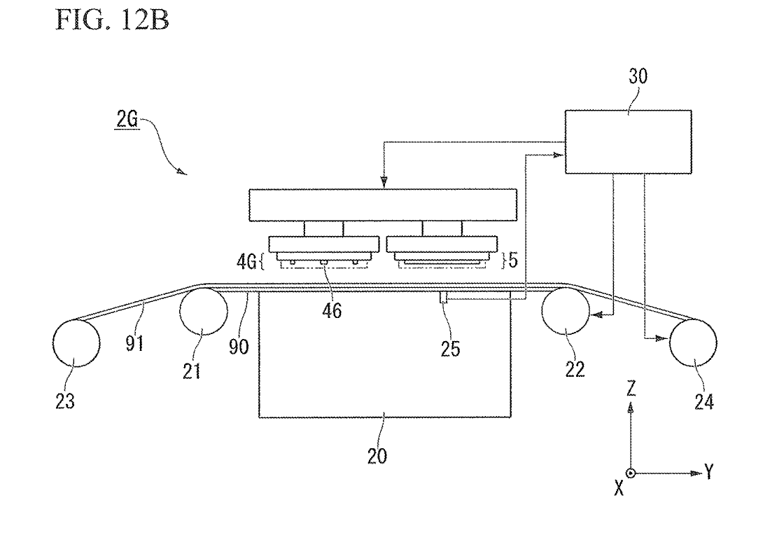

FIG. 12A is a top view illustrating an electrode plate manufacturing apparatus according to a fifth modified embodiment, and FIG. 12B is a side view of the electrode plate manufacturing apparatus according to the fifth modified embodiment. The fifth modified embodiment is different from the first embodiment in that a detecting means that detects a relative position of the first and second cutting blades and a portion of the original plate to be die-cut is provided.

As illustrated in FIGS. 12A and 12B, the original plate die manufacturing apparatus according to the fifth modified embodiment includes a mark forming portion 46 and a mark detecting portion 25 as a detecting means. The mark forming portion 46 is arranged further upstream in the conveying direction than the mark detecting portion 25. The mark forming portion 46 forms an alignment mark detectable by the mark detecting portion 25 in the original plate 91.

The mark forming portion 46 is disposed in a first cutting die 4G. The mark forming portion 46 is disposed to come in contact with the non-formation area 93 of the original plate 91 when the first cutting die 4G presses the original plate 91. The mark forming portion 46 comes in contact with the original plate 91 and forms a through hole at the contact position as the alignment mark. Thus, the alignment mark is formed at the position associated with the position of the first cutting portion 94ₙ and 94ₙ₊₁ illustrated in FIG. 6A.

The mark detecting portion 25 is disposed on the original plate support portion 20. The mark detecting portion 25 includes a photo-sensitive element therein. The mark detecting portion 25 detects the position of the through hole by detecting light passing through the through hole formed by the mark forming portion 46. Since the mark detecting portion 25 is arranged near the original plate 91, the position of the through hole can be detected with a high degree of accuracy.

The mark detecting portion 25 is electrically connected to the control portion 30 and outputs a detection result to the control portion 30. The control portion 30 controls the conveying rollers 21 to 24 based on the detection result of the mark detecting portion 25 so that the first cutting portion can be conveyed up to a predetermined position. Thus, the relative position of the first cutting portion to the second cutting blades 51 and 52 can be controlled with a high degree of accuracy, and the electrode plate 15 of a highly accurate shape can be die-cut.

Further, as the mark forming portion, for example, one in which a coating material is attached to the original plate 91 at the position associated with the position of the first cutting portion may be used. Instead of the mark forming portion 46, alignment marks may be formed on the original plate 91, for example, at regular intervals in advance. In this case, the first cutting blade can come in contact with the original plate at the position associated with the position of the alignment mark based on a result of detecting the alignment mark. As a result, since the contact position between the original plate and the first cutting blade is already known, the contact position between the original plate and the first cutting blade is detected. When it is difficult to detect the alignment mark through the original plate 91, the mark detecting portion 25 is preferably disposed above the original plate support portion 20.

### Second Embodiment

Next, a description will be made in connection with an electrode plate manufacturing apparatus according to a second embodiment. The second embodiment is different from the first embodiment in that a cylindrical cutting die is provided instead of the flat plate-like cutting die.

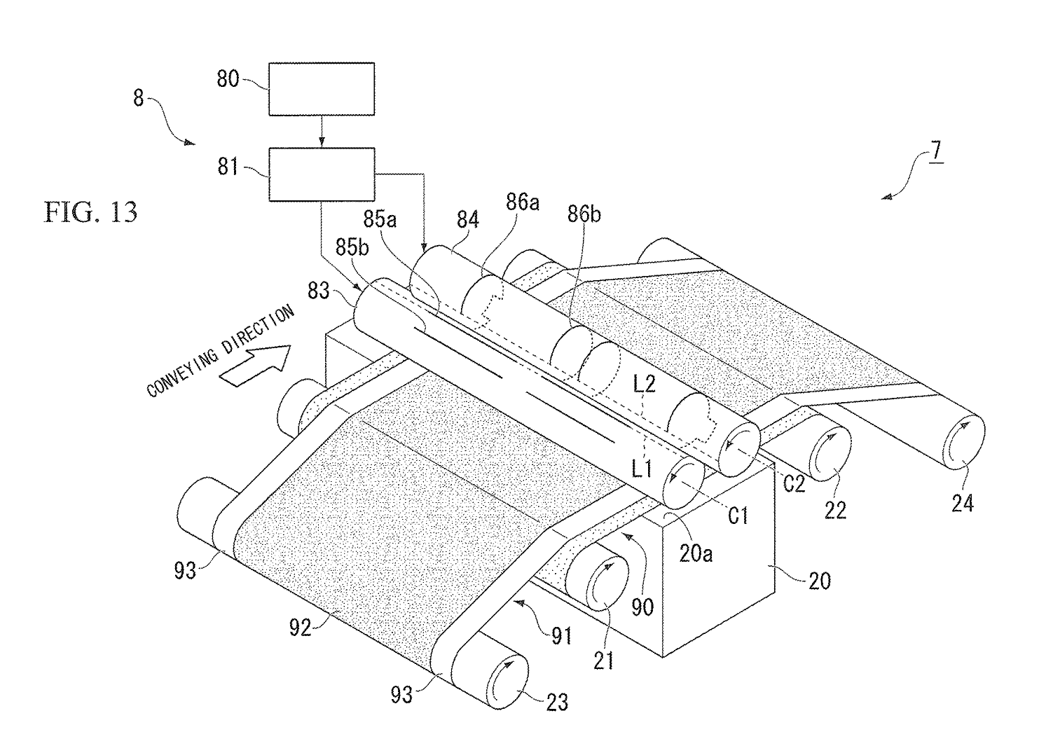

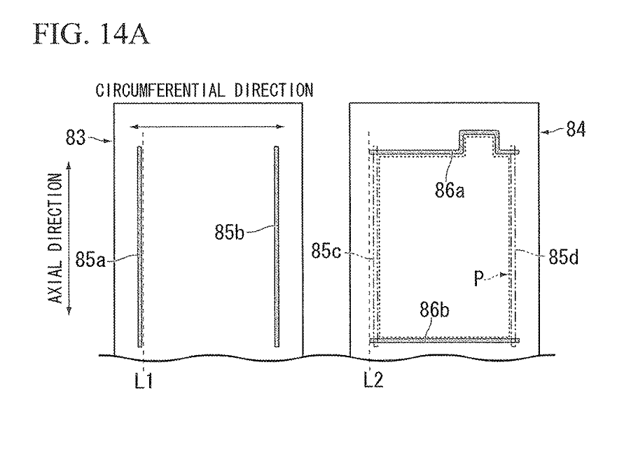

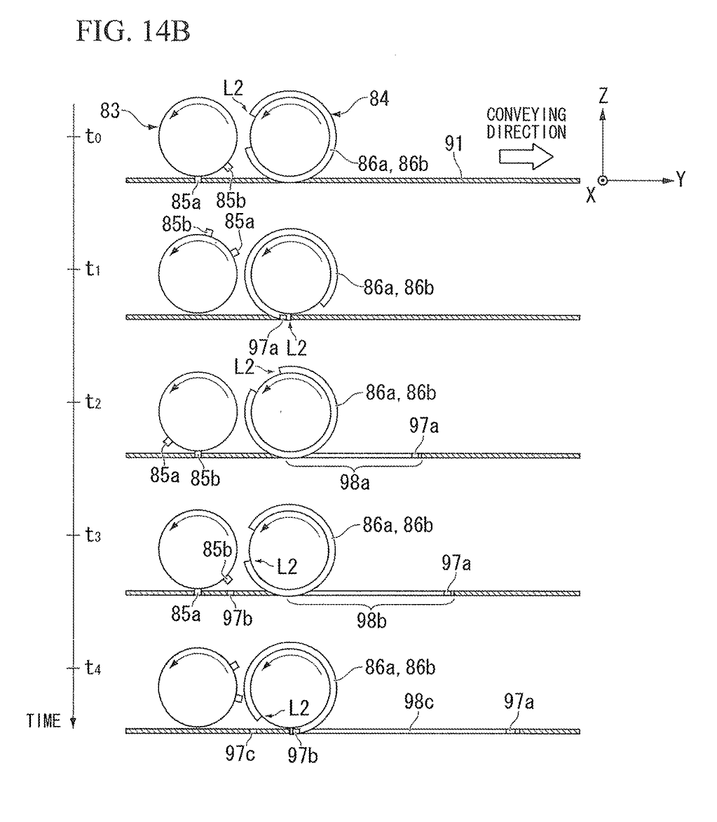

FIG. 13 is a perspective view illustrating a schematic configuration of the electrode plate manufacturing apparatus according to the second embodiment. FIG. 14A is a plan development view of first and second cutting blades, and FIG. 14B is an explanatory diagram illustrating a die-cutting process.

As illustrated in FIG. 13, an electrode plate manufacturing apparatus 7 according to the present embodiment includes an original plate support portion 20, a driving system 8, a first rotating body 83, and a second rotating body 84. The driving system 8 is configured with a conveying portion consisting of conveying rollers 21 to 24, a control portion 80, and a driving portion 81. Cutting blades which are deformed in a cylindrical shape and fixed to a support substrate, for example, rolling die-cutters, are provided on the first and second rotating bodies 83 and 84. The first and second rotating bodies 83 and 84 are rotationally controlled by the control portion 80.

The control portion 80 controls rotation of the conveying rollers 21 to 24 such that the original plate 91 and the protection sheet 90 are displaced in the conveying direction at a predetermined displacement speed. The driving portion 81 is controlled by the control portion 80 and rotates the first rotating body 83 and the second rotating body 84 at the same circumferential speed as the displacement speed.

Thus, the first rotating body 83 and the second rotating body 84 rotate while coming in contact with the original plate 91 without slipping.

The first rotating body 83 is one in which first cutting blades 85a and 85b are disposed on the outer circumferential surface of a cylindrical support portion. The first rotating body 83 is supported to be rotatable on a central axis C1. The central axis C1 is parallel to the upper surface 20a of the original plate support portion 20 and orthogonal to the conveying direction. Here, two sets of first cutting blades 85a and 85b are disposed at the positions to be line-symmetric to an imaginary line extending from the center of the formation area 92 of the original plate 91 in the X direction to the Y direction which is the conveying direction. The first rotating body 83 is arranged so that the first cutting blades 85a and 85b can come in contact with the original plate 91 supported on the upper surface 20a with the rotation of the first rotating body 83.

The second rotating body 84 is one in which second cutting blades 86a and 86b are disposed on the outer circumferential surface of a cylindrical support portion. The diameter of the support portion of the second rotating body 84 is the same as that of the first rotating body 83. Thus, the circumferential speeds of the first rotating body 83 and the second rotating body 84 can easily become uniform. The second rotating body 84 is supported to be rotatable on a central axis C2 substantially parallel to the central axis C1. Here, two sets of second cutting blades 86a and 86b are disposed at the positions to be line-symmetric to an imaginary line extending from the center of the formation area 92 of the original plate 91 in the X direction to the Y direction which is the conveying direction. The second rotating body 84 is arranged so that the second cutting blades 86a and 86b can come in contact with the original plate 91 supported on the upper surface 20a with the rotation of the second rotating body 84.

As illustrated in FIG. 14A, when the outer circumferential surface of the support portion that configures the first rotating body 83 is developed into a plane surface, the planar shapes of the first cutting blades 85a and 85b have the same patterns (see FIG. 5A) as in the first embodiment. However, as will be described later, the electrode plate to be die-cut has a shape which is bilaterally symmetric to an imaginary line extending from the center in a Y axis direction to an X axis direction.

The first cutting blades 85a and 85b extend in an axial direction of the support portion. In FIGS. 13 and 14A, reference numeral L1 refers to a reference line representing the position at which the first cutting blades 85a and 85b initially come in contact with a portion of the original plate 91 corresponding to a die-cutting target portion. Reference numeral L2 refers to a reference line representing the position at which the second cutting blades 86a and 86b initially come in contact with a portion of the original plate 91 corresponding to a die-cutting target portion.

Unlike the first embodiment in which an intermittent operation is performed, the first rotating body 83, the second rotating body 84, and the conveying rollers 21 to 24 rotate without stopping in the process of die-cutting the electrode plate. As illustrated in FIG. 14B, at a time t₀, the first cutting blade 85a comes in contact with the original plate 91, so that a first cutting portion 97a is formed. The first cutting portion 97a corresponds to the long side 152 of the electrode plate 15 (hereinafter, see FIG. 2A).

The original plate 91 is conveyed with the rotation of the first rotating body 83 and the second rotating body 84, and at a time t₁, the first cutting portion 97a comes in contact with the second rotating body 84. When the first cutting portion 97a is closest to the second rotating body 84, the second rotating body 84 comes in contact with the original plate 91 near the reference line L2.

Next, the second cutting blades 86a and 86b cut the original plate 91, so that second cutting portions 98a and 98b are formed, and the original plate 91 is conveyed. The second cutting portions 98a and 98b correspond to parts of the short sides 154 and 155 and part of the electrode tab 151 of the electrode plate 15. At a time t₂, the first cutting blade 85b comes in contact with the original plate 91, so that a first cutting portion 97b is formed. The first cutting portion 97b corresponds to the long side 153 of the electrode plate 15. Then, at a time t₃, the first cutting blade 85a comes in contact with the original plate 91, so that a first cutting portion 97c is formed. The first cutting portion 97c is a portion of the long side 152 of the electrode plate which is to be die-cut next.

At a time t₄, die-cutting of the electrode plate is completed. In the above described manner, the electrode plate is continuously die-cut.

In the electrode plate manufacturing apparatus 7 according to the second embodiment, since the first cutting portion and the second cutting portion corresponding to the two sides connected to the corner portion of the electrode plate 15 are formed at different timings, the electrode active material does not easily separated from the collector at the corner portion of the electrode plate 15.

The first cutting blades 85a and 85b and the second cutting blades 86a and 86b are disposed along the outer circumferential surface of the cylindrical support portion, and thus the apparatus size can be reduced in the direction parallel to the surface of the original plate 91 compared to the planar cutting die. Further, since the original plate 91 can be die-cut during the conveyance, efficiency of die-cutting the original plate 91 can be improved as much as the conveyance does not stop.

The exemplary embodiments of the present invention have been described above, but the present invention is not limited to the above embodiments. Addition, omission, replacement, and other alternation can be made in a range not departing from the gist of the present invention. The present invention is not limited to the above description and confined only by the accompanying claims.

### INDUSTRIAL APPLICABILITY

According to the electrode plate manufacturing apparatus, separation of the electrode active material can be minimized when the electrode plate is die-cut, and thus the manufacturing yield can be improved.

### DESCRIPTION OF REFERENCE NUMERALS

1: Battery cell
2: Electrode plate die-cutting apparatus
3: Driving system
4, 4B, 4E, 4F, 4G, 5, 5B, 5C, 5D, 5E: Cutting die
7: Electrode plate die-cutting apparatus
8: Driving system
10: Battery container
11: Container body
12: Cover
13, 14: Electrode terminal
15, 15B, 16: Electrode plate
17: Separator
20: Original plate support portion
20a: Upper surface
21 to 24: Conveying roller
25: Mark detecting portion (detecting means)
30: Control portion
31: Driving portion
32, 32F, 33: Holding portion
34 to 37: Support post
40: First support substrate
40F: Support substrate
40a: Facing surface
41, 41B, 42: First cutting blade
43, 43E: First pressing portion
43F: Pressing portion
43a: Surface
44: First blade element
44a: First imaginary blade element
45: Second blade element
45a: Second imaginary blade element
46: Mark forming portion (detecting means)
46E, 47E: Notch
50: Second support substrate
51, 51B, 51C, 51D, 52: Second cutting blade
53, 53E: Second pressing portion
54: Third blade element
55: Fourth blade element
56E, 57E: Notch
80: Control portion
81: Driving portion
83: First rotating body
84: Second rotating body
85a, 85b: First cutting blade
85c, 85d: First imaginary cutting blade
86a, 86b: Second cutting blade
90: Protection sheet
91: Original plate
92: Formation area
93: Non-formation area
94: First cutting portion
94a to 94c: End portion
94n, 94n+1: First cutting portion
95: Second cutting portion
96: Void portion
97a to 97c: First cutting portion
98a to 98c: Second cutting portion
150, 150B: Electrode body portion
151: Electrode tab
152, 153: Long side
154, 155: Short side
152B to 159B: Side
156: Collecting material
157: Electrode active material
158: Formation area
159: Non-formation area
161: Electrode tab
441: One surface
442: Other surface
443: Blade edge
911: Current collecting material
912, 913: Electrode active material
C1, C2: Central axis
F0: Elastic repulsive force
F1˜F4: Compression force
F5, F6: Component force
L: Tangential line
L1: Reference line
L2: Reference line
P: Shape
P1, P2: First extension portion
P3, P4: Second extension portion
P5: Tab forming portion
P6 to P9: First to fourth corner portions
Q: Shape
t₀ to t₄: Time

1. An electrode plate manufacturing apparatus, comprising:
an original plate support portion that supports an original plate of an electrode plate coated with an electrode active material;
a first cutting blade that forms a linear first cutting portion in the original plate;
a first support substrate, which is arranged to face the original plate support portion, having the first cutting blade fixed thereto;
a second cutting blade that forms a linear second cutting portion in the original plate;
a second support substrate, which is arranged to face the original plate support portion, having the second cutting blade fixed thereto; and
a driving portion that drives the first and second support substrates,
wherein, when the first support substrate is driven by the driving portion, the first cutting portion is formed by the first cutting blade, and
when the second support substrate is driven by the driving portion, on the original plate in which the first cutting portion is formed, the second cutting portion is formed to intersect with the first cutting portion by the second cutting blade.

2. The electrode plate manufacturing apparatus according to claim 1, wherein the driving portion drives the first and second support substrates to move toward the original plate support portion or retreat from the original plate support portion.

3. The electrode plate manufacturing apparatus according to claim 2, further comprising:
a control portion; and
a conveying roller that conveys the original plate through the original plate support portion,
wherein the control portion intermittently drives the conveying roller; forms the first cutting portion by stopping the conveying roller and causing the first support substrate to move toward the original plate support portion when the original plate is arranged at a first position on the original plate support portion; and forms the second cutting portion by stopping the conveying roller and causing the second support substrate to move toward the original plate support portion when the original plate in which the first cutting portion is formed is arranged at a second position.

4. The electrode plate manufacturing apparatus according to claim 1, wherein the first support substrate is fixed to a first rotating body,
the second support substrate is fixed to a second rotating body arranged in parallel to the first rotating body, and
the driving portion forms the first cutting portion and the second cutting portion at different timings by rotationally driving the first and second rotating bodies.

5. The electrode plate manufacturing apparatus according to claim 4, further comprising:
a control portion; and
a conveying roller that conveys the original plate through the original plate support portion,
wherein the control portion causes the conveying roller and the first and second rotating bodies to rotate at the same speed.

6. The electrode plate manufacturing apparatus according to claim 3, further comprising:
a first pressing portion, which is fixed to the first support substrate, is arranged with a predetermined gap from the first cutting blade; and
a second pressing portion, which is fixed to the second support substrate, is arranged with a predetermined gap from the second cutting blade.

7. The electrode plate manufacturing apparatus according to claim 5, further comprising:
a first pressing portion, which is fixed to the first support substrate, is arranged with a predetermined gap from the first cutting blade; and
a second pressing portion, which is fixed to the second support substrate, is arranged with a predetermined gap from the second cutting blade.
